(19) United States
(12) Patent Application Publication
(10) Pub. No.: US 2013/0070581 A1
(43) Pub. Date: Mar. 21, 2013

(54) Controlling Data Transmission

(71) Applicants: James Michael Clark, Cambridgeshire (GB); Nicholas John Jones, Cambridgeshire (GB)

(72) Inventors: James Michael Clark, Cambridgeshire (GB); Nicholas John Jones, Cambridgeshire (GB)

(73) Assignee: CAMBRIDGE SILICON RADIO LIMITED, Cambridge (GB)

(21) Appl. No.: 13/237,380

(22) Filed: Sep. 20, 2011

(30) Foreign Application Priority Data
Sep. 20, 2011 (GB) 1116245.0

(51) Int. Cl. H04L 29/14; H04L 29/06

(52) U.S. Cl. 370/216

(57) ABSTRACT

A method of controlling data transmission at a transmitter, the transmitter comprising a link controller that reads data from a buffer for transmission, the transmitter operating according to a protocol in which it is mandatory for the link controller to retransmit a packet until that packet is acknowledged, the method including, at the link controller: transmitting a data packet, the payload of the data packet comprising the first data read from the buffer; determining to retransmit the data packet due to lack of receipt of an acknowledgment that the data packet was received; determining whether the first data in the buffer is still timely; and if the first data in the buffer is not still timely, deleting the first data from the buffer and replacing it with second data, and retransmitting the data packet wherein the payload of the retransmitted data packet comprises the second data read from the buffer.

### BACKGROUND OF THE INVENTION

The present invention relates to controlling the transmission of data at a transmitter, for example controlling the transmission of time critical data.

Many communication protocols define an acknowledgment procedure for the communication of messages between devices. Typically, an acknowledgment procedure requires that a receiver acknowledges the receipt of each packet or group of packets from a transmitter by sending an acknowledgment packet back to the transmitter. If the transmitter does not receive an acknowledgment for a packet it has transmitted then it retransmits that packet. Protocols often require that a packet continues to be retransmitted until the transmitter receives an acknowledgment from the receiver that that packet has been received. This ensures reliable transfer to the receiver of all the data transmitted by the transmitter.

Bluetooth Low Energy devices as defined in the Bluetooth Specification v4.0 are required to use reliable data connections. Such devices are bound by their operating protocols to retransmit packets until they receive an acknowledgment from the receiver.

For the purpose of transmitting delivery critical data (DCD), i.e. data for which the delivery of the data is more important than the timeliness of the data transmittal, retransmitting packets until receipt of an acknowledgment from the receiver ensures reliable delivery and is not problematic. However, for the purpose of transmitting time critical data (TCD), i.e. data for which the timeliness of the transmittal is more important than that all the data is reliably delivered, retransmitting packets until receipt of an acknowledgment from the receiver is problematic because it introduces high latency into the communication of the data. The problem is exacerbated when the qualities of the links between the transmitter and receiver are low, because the lower the quality, the fewer the number of packets being received and acknowledged first time, the more retransmissions are required, the higher the latency. For real-time communications such as audio, this high latency is particularly problematic.

Thus, there is a need for an improved method of controlling data transmission at a transmitter that is bound to continue retransmitting a packet until it receives an acknowledgment, the method being more suitable for the transmission of time critical data.

### SUMMARY OF THE INVENTION

According to a first aspect of the invention, there is provided a method of controlling data transmission at a transmitter, the transmitter comprising a link controller that reads data from a buffer for transmission, the transmitter operating according to a protocol in which it is mandatory for the link controller to retransmit a packet until that packet is acknowledged, the method including, at the link controller: transmitting a data packet, the payload of the data packet comprising first data read from the buffer; determining to retransmit the data packet due to lack of receipt of an acknowledgment that the data packet was received; determining whether the first data in the buffer is still timely; and if the first data in the buffer is not still timely, deleting the first data from the buffer and replacing it with second data, and retransmitting the data packet wherein the payload of the retransmitted data packet comprises the second data read from the buffer.

According to a second aspect of the invention, there is provided a transmitter operable in accordance with a protocol in which it is mandatory for the transmitter to retransmit a packet until that packet is acknowledged, the transmitter including: a buffer configured to store data to be transmitted; and a link controller configured to read data from a buffer for transmission, the link controller operable to: transmit a data packet, the payload of the data packet comprising first data read from the buffer; determine to retransmit the data packet due to lack of receipt of an acknowledgment that the data packet was received; determine whether the first data in the buffer is still timely; and if the first data in the buffer is not still timely, delete the first data from the buffer and replace it with second data, and retransmit the data packet wherein the payload of the retransmitted data packet comprises the second data read from the buffer.

### BRIEF DESCRIPTION OF THE DRAWINGS

The following disclosure will now be described by way of example with reference to the accompanying drawings. In the drawings:

FIG. 1 illustrates a layered protocol stack according to one aspect of the invention;

FIG. 2 is a flow chart illustrating a method of controlling retransmitted data at a link controller in accordance with one embodiment of the invention;

FIG. 3 is a flow chart illustrating a method of controlling data transmission at a link controller in accordance with one embodiment of the invention; and

FIG. 4 illustrates a schematic diagram of an exemplary transmitter in accordance with one embodiment of the invention.

### DETAILED DESCRIPTION OF THE INVENTION

The following disclosure is directed at an effective way of controlling the transmission of data from a transmitter that operates according to a protocol in which it is mandatory for the transmitter to retransmit a data packet until it receives an acknowledgment (ACK) from the receiver confirming receipt of the data packet, but where time-sensitive data is required to be transmitted.

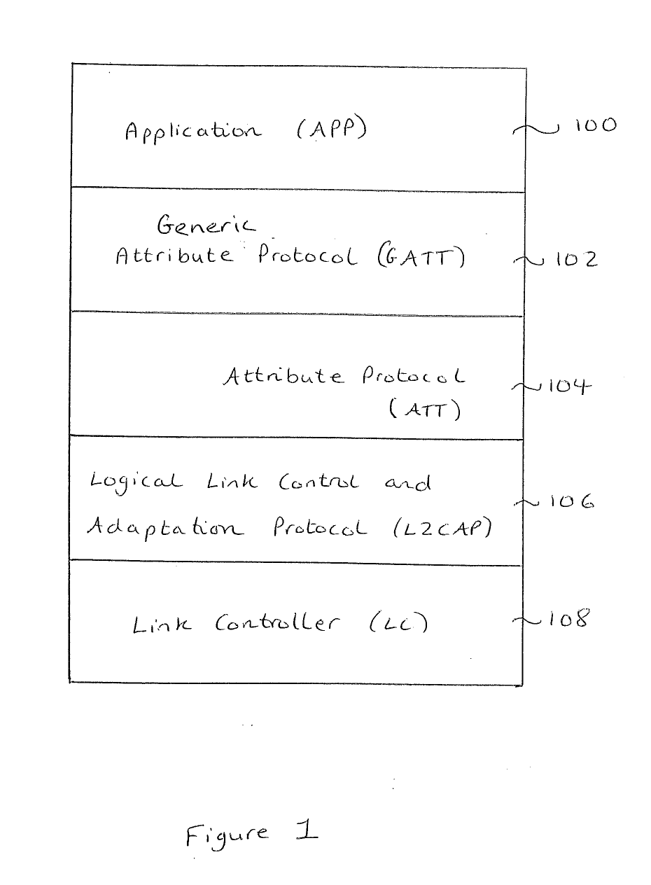

As mentioned above, Bluetooth Low Energy (BLE) devices are an example of devices required by the protocols according to which they operate (as defined in the Bluetooth Specification v4.0) to retransmit a packet until receipt of an ACK from the receiver that that packet has been successfully received. For the purposes of communicating data, BLE devices operate according to the layered protocol stack structure illustrated in FIG. 1. The Application (APP) layer 100 is at the top of the stack. This is followed by the Attribute

Protocol (ATT) layer 102, the Generic Attribute Protocol (GATT) layer 104, the Logical Link Control and Adaptation Protocol (L2CAP) layer 106 and the Link Controller (LC) layer 108. These layers are defined in the Bluetooth Specification v4.0. All of these layers may be implemented in software. Alternatively, the Link Controller layer may be partially or entirely implemented in hardware.

Two types of acknowledgment schemes are defined in the Bluetooth Specification v4.0: indications and notifications. Indications are messages that incorporate an ACK received and processed by the LC layer and an ACK received and processed by the APP layer. This means that the transmitted packet is known to have been reliably transmitted at both the LC layer and the APP layer. Notifications are messages that incorporate an ACK received and processed by the LC layer only. The transmission of the packet is thus reliable at the LC layer but not at the APP layer. Notifications are more suitable than indications for Bluetooth Low Energy devices because they require a much lower overhead as a result of not providing an ACK at the APP layer.

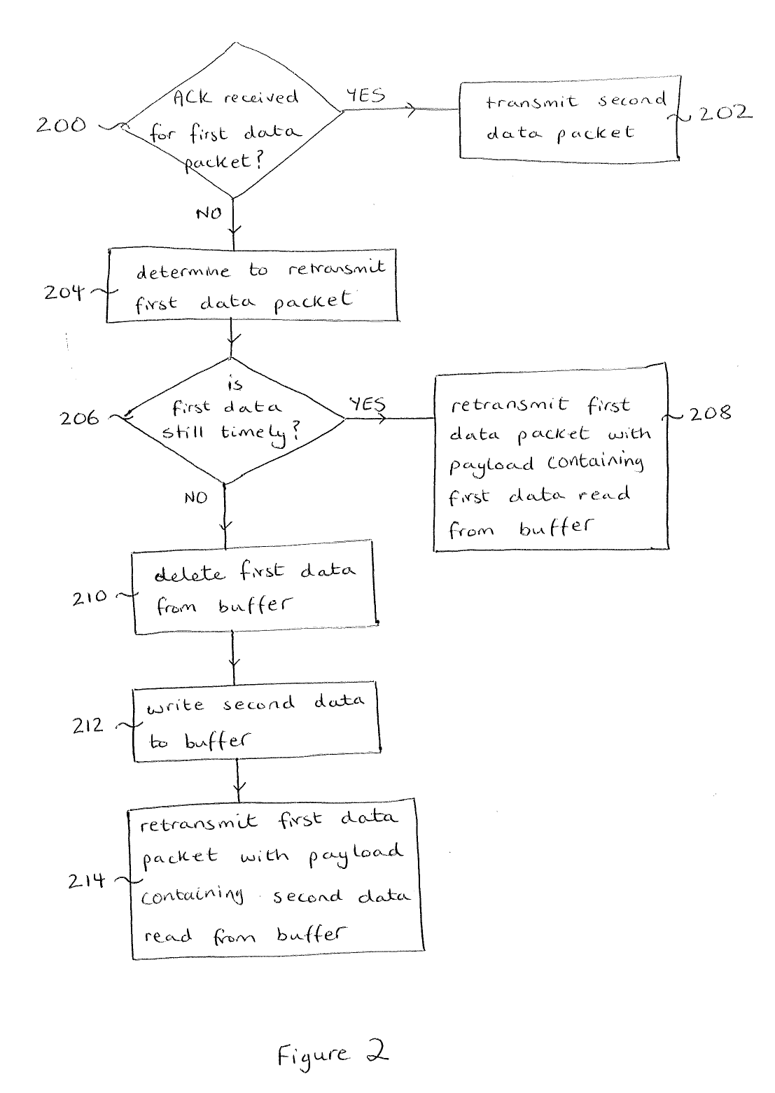

Suitably then, in an exemplary system comprising two BLE devices operating in accordance with the Bluetooth Specification v4.0, the receiver uses notifications to acknowledge receipt of a data packet transmitted by the transmitter. Control of retransmissions primarily resides with the link controller which is the only layer in the protocol stack of FIG. 1 which receives ACKs from the receiver in this exemplary system. Suitably, the link controller reads data for transmission from a buffer. Each buffered data set has associated with it an indication of timeliness. In an exemplary method, the link controller uses this indication of timeliness to control retransmissions as will now be explained with reference to FIG. 2.

At step 200, the link controller determines whether an ACK has been received from the receiver for a first data packet comprising first data transmitted by the transmitter. Suitably, the link controller has a timeframe following transmittal of each data packet in which it expects to receive an ACK for that packet from the receiver. If the ACK has not been received within this timeframe, the link controller determines to retransmit the data packet. If the ACK for the first data packet is received then the link controller transmits the second data packet to the receiver (step 202). Preferably, the second data packet is the next packet after the first data packet in the sequence of data packets to be transmitted. However, If the ACK for the first data packet is not received then the link controller determines to re-transmit the first data packet (step 204). At step 206, the link controller determines if the first data is still timely. If the first data is still timely, then at step 208, the link controller retransmits the first data packet in which the payload comprises the first data read from the buffer. If the first data is not still timely, then at step 210 the link controller deletes the first data from the buffer. Second data is written to the buffer in step 212. Then, at step 214, the link controller retransmits the first data packet in which the payload comprises the second data read from the buffer. The payload does not comprise the first data. As an alternative to steps 212 and 214, the second data may have already been written to a second buffer. The link controller then retransmits the first data packet in which the payload comprises the second data read from the second buffer. The payload does not comprise the first data.

In this way, the transmitter operates according to a protocol which mandates that a packet is to be retransmitted until it is acknowledged, but reduces the latency of the data transmission by replacing non-timely data with more recent data in the retransmitted packets. Thus, this method is more suitable for the transmission of time critical data.

Additionally, latency in the data transmission is further reduced by implementing the methods described herein at the link controller layer of the protocol stack illustrated in FIG. 1 rather than any of the higher layers. It takes time for each layer to process signals and provide an output to the layer above. Thus, providing the functionality to control the data content of the transmissions and retransmissions at the link controller rather than up at, for example, the APP layer, minimises the processing time at the transmitter and hence minimises latency in the data transmission. Thus, this method is more suitable for the transmission of time critical data.

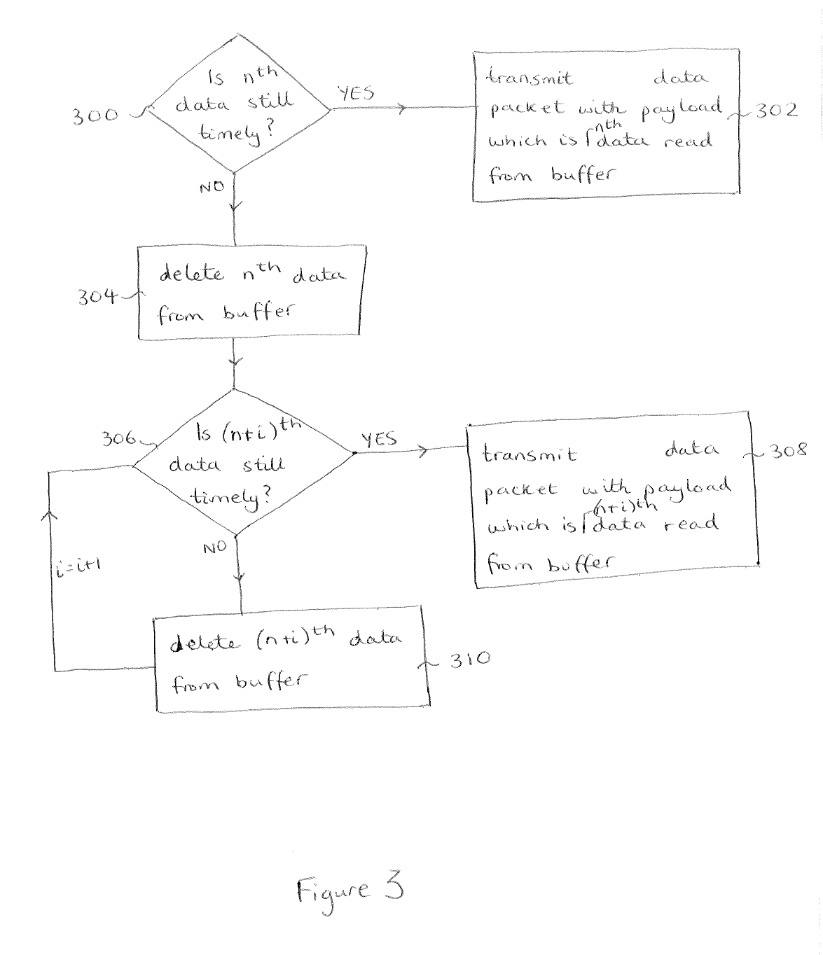

Optionally, the determination to transmit data only if it is still timely is applied to all transmissions of that data, including the first transmission of that data. FIG. 3 illustrates this process. Nth data is written to a buffer. At step 300, the link controller determines if the nth data is still timely. If the answer is yes, then at step 302, the link controller transmits a data packet with a payload which comprises the nth data read from the buffer. If the answer is no, then at step 304, the link controller deletes the nth data from the buffer. The link controller then moves on to assessing the next data, i.e. the (n+i)th data where i=1. In step 306, the link controller determines if the (n+i)th data is still timely. If the answer is yes, then at step 308, the link controller transmits a data packet with a payload which comprises the (n+i)th data. If the answer is no, then at step 310, the link controller deletes the (n+i)th data from the buffer. Steps 306 and 310 iterate assessing each consecutive data until the link controller assesses that a data is still timely, at which point that data is incorporated into a data packet and transmitted.

Suitably, when the link controller determines that a data packet is to be retransmitted, but that the data in that data packet is no longer timely, the link controller preferably assesses the next data to determine if it is timely. If the next data is timely, the link controller transmits the next data in the payload of the retransmitted packet. However, if the next data is not timely, that data is deleted from the buffer, and the link controller assesses whether the data after that is timely. The iterative process continues until the link controller determines that some data is timely. Then the timely data is incorporated into the payload of the retransmitted packet and transmitted.

Suitably, each data unit which is assessed by the link controller for timeliness has associated with it an indication of timeliness applied by a higher layer in the protocol stack. The link controller interprets this indication of timeliness in order to determine whether the data is still timely.

For example, the indication of timeliness may be a timestamp. This timestamp may set an expiry time. The expiry time may be an absolute time after which the data associated with the timestamp is not to be transmitted. This absolute time may be relative to a clock in the transmitter. For example, this absolute time may be relative to a Bluetooth clock of the transmitter. Suitably, the timestamp is configurable in dependence on a property of the data being transmitted. As an example, delivery critical data is suitably allocated a long timestamp. This is because the priority for delivery critical data is that it is reliably transmitted, not that it is transmitted quickly. Suitably, the timestamp is infinity. This means that the link controller will always determine that the data is still timely, and will hence always opt to retransmit the data rather than replace the data with more recent data for retransmission. Time critical data, on the other hand, is suitably allocated a short timestamp. This is because the priority for time critical data is that it is transmitted quickly, not that it is transmitted reliably. Thus, the link controller is able to control the latency on the link by replacing data for transmission whenever the acceptable latency limit of the data has been exceeded.

As a further example, the indication of timeliness may be a retry count. This retry count sets a limit to the number of times a transmitter will attempt to transmit the same data.

Suitably, this retry count is configurable in dependence on a property of the data being transmitted. For example, delivery critical data is suitably allocated a high retry count. Suitably, the retry count for delivery critical data is infinity. Time critical data, on the other hand, is suitably allocated a small retry count. Suitably, the retry count for time critical data is 1 or 2.

Suitably, the APP layer generates data units for transmission and also generates metadata associated with each data unit. Suitably, this metadata incorporates information which the link controller interprets as an indication of timeliness. For example, the metadata incorporates the timestamp described above. Alternatively, the metadata incorporates the retry count described above. The link controller analyses the metadata associated with data in the buffer, and based on this analysis chooses to delete the data in the buffer or incorporate it into a data packet for transmission. Suitably, the metadata itself is not transmitted. If the link controller concludes that the data is no longer timely, then it deletes the data and its associated metadata. If the link controller transmits a data packet and receives an ACK, then it deletes the data and its associated metadata. If the link controller determines that data is still timely, it transmits the data but does not discard the data and its associated metadata. This is because if no ACK is received, then the link controller again analyses the metadata and determines to retransmit the data based on the timeliness of the data as indicated in the metadata.

Suitably, the link controller applies a sequence number to each data packet that it transmits. This sequence number is associated with the payload of the data packet. Typically, consecutive packets are allocated consecutive sequence numbers in a sequence which is specified by the protocol according to which the transmitter and receiver operate. The receiver expects consecutive packets that it receives to have consecutive sequence numbers in the sequence. In BLE, the sequence number sequence 101010101010 . . . is used. So, in the example of two BLE devices communicating, the receiver expects consecutive received packets to alternate between having sequence number 0 and sequence number 1. Receipt of two packets having the same sequence number in a row is interpreted by the receiver as receipt of the same packet twice, and hence it discards the second received packet and does not send it up to the higher layers in the stack. This would happen, for example, if the receiver received a packet having sequence number 1 and sent an ACK to the transmitter, but the transmitter did not receive the ACK and hence retransmitted the same packet having sequence number 1.

When a transmitter does not receive an ACK of a packet from a receiver, it is ambiguous to the transmitter whether this is because (i) the receiver did not receive the packet; or (2) the receiver received the packet but the transmitter did not receive the ACK. In such a situation, according to the above described methods, the transmitter may determine that the originally transmitted data is no longer timely and decide to transmit more recent data in the retransmitted packet. Consider the originally transmitted packet to have had a sequence number 1. The transmitter may determine to retransmit the packet with the same sequence number as the originally transmitted packet. If the transmitter retransmits the packet with the same sequence number as the originally transmitted packet, in this example sequence number 1, and if the receiver did not receive the original packet, and hence is still expecting a packet with sequence number 1, then the receiver receives this packet and passes the recent data up the stack. However, if the transmitter retransmits the packet with sequence number 1, but the receiver had received the original packet, then the receiver deletes the recent data without passing it up the stack, because the receiver is expecting a packet with sequence number 0 and hence interprets the receipt of a packet with sequence number 1 as a retransmission of a packet it has already received.

Alternatively, the transmitter may retransmit the packet with the next number in the sequence after the sequence number of the originally transmitted packet. In the example of the previous paragraph, the transmitter transmits the retransmitted packet with sequence number 0. In this case, the receiver receives this packet and, if the receiver did receive the original packet and hence is expecting a packet with sequence number 0, the receiver passes the recent data up the stack. However, if the transmitter retransmits the packet with sequence number 0, but the receiver had not received the original packet, then the receiver deletes the recent data without passing it up the stack, because the receiver is expecting a packet with sequence number 1 and hence interprets the receipt of a packet with sequence number 0 as a retransmission of a packet it has already received.

Suitably, the transmitter chooses to (i) maintain the sequence number of the retransmitted packet to be the same as that of the originally transmitted packet; or (ii) change the sequence number of the retransmitted packet to be the next sequence number in the sequence that the receiver expects to receive, based on an indication of whether it is more likely that the receiver did not receive the original packet or that the transmitter did not receive the ACK from the receiver. For example, this indication may be based on an analysis of the link quality on the downlink to the receiver and the uplink from the receiver. If the downlink quality is lower than the uplink quality, then it is more likely that the receiver did not receive the original packet. In this case, the transmitter suitably transmits the retransmitted packet with the same sequence number as the originally transmitted packet.

On the other hand, if the uplink quality is lower than the downlink quality, then it is more likely that the receiver received the original packet but that the transmitter did not receive the ACK. In this case, the transmitter suitably transmits the retransmitted packet with the next sequence number in the sequence that the receiver expects to receive. The quality may be based on a signal to noise ratio, an error rate, RSSI or similar measure.

A receiver implemented solution to the above-described sequence number problem is to pass data up the stack even if the receiver interprets a packet to have been received twice.

The methods described herein are suitable for application to the transmission of any type of data because the determination of whether the data is still timely or not is configurable for different types of data as previously explained. If it is more important that data is reliably delivered to the recipient than that the data gets to the recipient quickly, then the data is considered to still be timely for longer than if it is more important that data is delivered to the recipient quickly than that it is delivered to the recipient reliably. The methods described herein are particularly suitable for use with time critical data which is being transmitted in accordance with a protocol in which the transmitter is bound to retransmit a packet until an ACK is received, because these methods reduce the latency involved with the transmission of such data. The methods described herein are particularly suitable for the transmission of real time data. Examples of applications transmitting time critical data are: monitoring applications, for example a thermometer which regularly communicates a temperature; handheld gaming devices for which the demand for low latency is high for the communication of control signals; and the transmission of audio signals for which low latency is also of particularly high demand.

Although Bluetooth Low Energy devices have been referred to in the examples herein, this is just an example. The disclosure applies to any transmitter whose link controller is restricted by a protocol which it operates in accordance with, to continue retransmitting data packets until they are acknowledged.

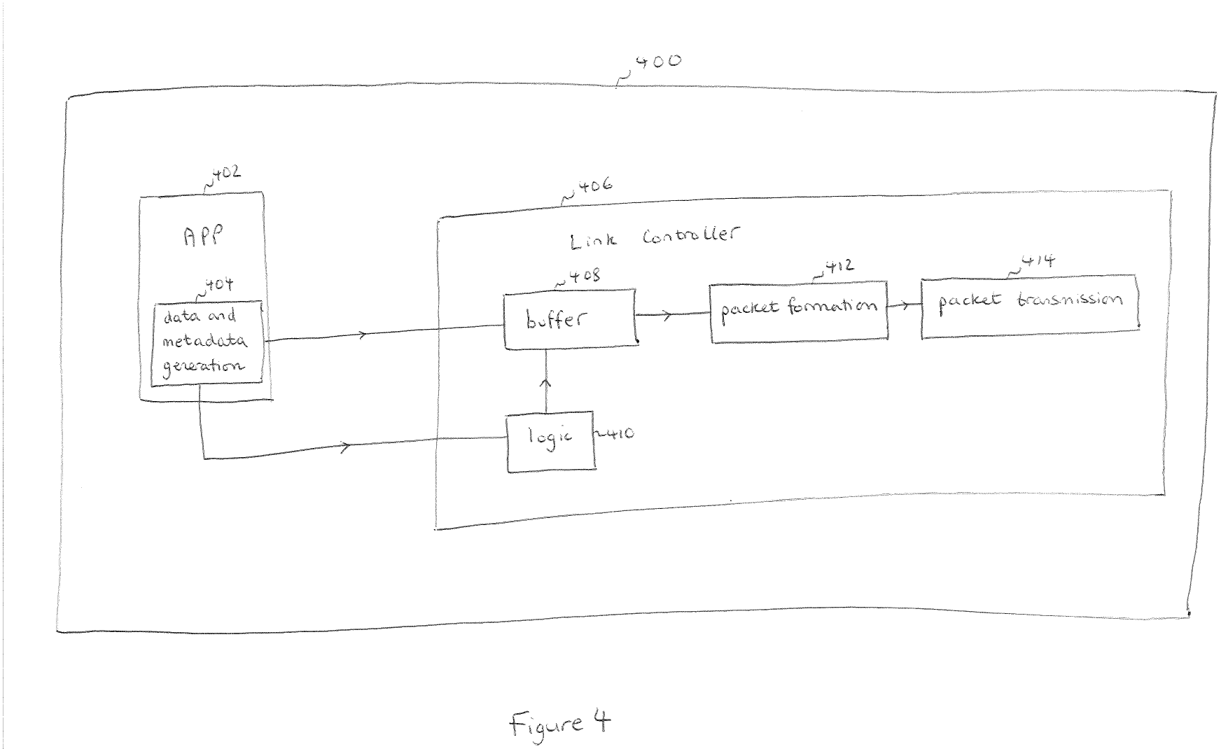

FIG. 4 illustrates a schematic diagram of an exemplary transmitter according to the methods described herein. Transmitter 400 comprises an application 402 and a link controller 406. The application incorporates a module for data and metadata generation 404. Link controller 406 incorporates a buffer 408 which stores data from the application. Link controller also incorporates logic 410 which receives and interprets metadata associated with the buffered data from the application. Logic 410 controls the buffer 408 to either delete its contents or output them to packet formation unit 412. Packet formation unit 412 generates a packet by formatting the data into a payload and including a header. Following packet formation the data packet is output to packet transmission unit 414 for transmission. Packet transmission unit 414 incorporates functionality known in the art, for example modulation, shaping, frequency mixing etc. It is understood that FIG. 4 illustrates the layout of a transmitter in terms of functional boxes. The operations of one or more of these functional boxes may be combined or performed by separate components. It will be understood that this figure does not illustrate those conventional components of the transmitter known to a person skilled in the art.

Preferably, the link controller described herein is implemented in software. Alternatively, the link controller is implemented in hardware.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. A method of controlling data transmission at a transmitter, the transmitter comprising a link controller that reads data from a buffer for transmission, the transmitter operating according to a protocol in which it is mandatory for the link controller to retransmit a packet until that packet is acknowledged, the method comprising, at the link controller:
transmitting a data packet, the payload of the data packet comprising first data read from the buffer;
determining to retransmit the data packet due to lack of receipt of an acknowledgment that the data packet was received;
determining whether the first data in the buffer is still timely; and
if the first data in the buffer is not still timely, deleting the first data from the buffer and replacing it with second data, and retransmitting the data packet wherein the payload of the retransmitted data packet comprises the second data read from the buffer.

2. A method according to claim 1, comprising determining that the first data in the buffer is still timely if a timestamp associated with the first data has not expired.

3. A method according to claim 2, wherein the timestamp is relative to a Bluetooth clock of the transmitter.

4. A method according to claim 2, wherein a timestamp associated with time critical data is shorter than a timestamp associated with delivery critical data.

5. A method according to claim 3, wherein a timestamp associated with time critical data is shorter than a timestamp associated with delivery critical data.

6. A method according to claim 1, comprising determining that the first data in the buffer is still timely if a retry count associated with the first data has not expired.

7. A method according to claim 1, wherein the transmitter further comprises an application, wherein the application generates data for transmission and metadata associated with the data for controlling the data transmission.

8. A method according to claim 5, wherein the transmitter further comprises an application, wherein the application generates data for transmission and metadata associated with the data for controlling the data transmission, and wherein the link controller interprets the metadata as comprising said timestamp.

9. A method according to claim 6, wherein the transmitter further comprises an application, wherein the application generates data for transmission and metadata associated with the data for controlling the data transmission, and wherein the link controller interprets the metadata as comprising said retry count.

10. A method according to claim 1, wherein if the first data in the buffer is still timely, the link controller retransmits the data packet wherein the payload of the retransmitted data packet comprises the first data read from the buffer.

11. A method according to claim 1, wherein the link controller applies a sequence number to each data packet, the sequence numbers of consecutive data packets being defined by the protocol, wherein if the first data in the buffer is not still timely, the link controller applies the same sequence number to the retransmitted data packet as was applied to the transmitted data packet.

12. A method according to claim 11, wherein the link controller applies the same sequence number based on a determination that the link quality of the downlink from the transmitter is worse than the link quality of the uplink to the transmitter.

13. A method according to claim 1, wherein the link controller applies a sequence number to each data packet, the sequence numbers of consecutive data packets being defined by the protocol, wherein if the first data in the buffer is not still timely, the link controller applies the sequence number of the subsequent packet to the retransmitted data packet.

14. A method according to claim 13, wherein the link controller applies the sequence number of the subsequent packet based on a determination that the link quality of the downlink from the transmitter is better than the link quality of the uplink to the transmitter.

15. A transmitter operable in accordance with a protocol in which it is mandatory for the transmitter to retransmit a packet until that packet is acknowledged, the transmitter comprising:
a buffer configured to store data to be transmitted; and
a link controller configured to read data from a buffer for transmission, the link controller operable to:
transmit a data packet, the payload of the data packet comprising first data read from the buffer;
determine to retransmit the data packet due to lack of receipt of an acknowledgment that the data packet was received;
determine whether the first data in the buffer is still timely; and
if the first data in the buffer is not still timely, delete the first data from the buffer and replace it with second data, and retransmit the data packet wherein the payload of the retransmitted data packet comprises the second data read from the buffer.

16. A transmitter according to claim 15, further comprising an application, wherein the application is configured to generate data for transmission and metadata associated with the data for controlling the data transmission.
